(19) United States
(12) Patent Application Publication
(10) Pub. No.: US 2010/0065485 A1
(43) Pub. Date: Mar. 18, 2010

(54) SHAFT TYPE SUBMERGED HOLLOW FIBRE MEMBRANE MODULE

(76) Inventors: Lianggang CHEN, Shanghai (CN); Man Chen, Shanghai (CN); Qing Chen, Shanghai (CN)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 12/619,858

(22) Filed: Nov. 17, 2009

Related U.S. Application Data
(63) Continuation of application No. PCT/CN2008/070966, filed on May 15, 2008.

(30) Foreign Application Priority Data
May 18, 2007 (CN) 200720069550.5

(51) Int. Cl. B01D 63/02

(52) U.S. Cl. 210/220

(57) ABSTRACT

The invention provides a shaft type submerged hollow fiber membrane module, comprising a hollow aerating shaft (1), an aerating head (2), hollow fiber membranes (4), an upper end head (5), a lower end head (6), an upper end cap (7), a lower end cap (8), a water-producing opening (9), an aerating gas inlet (10), a protective net (11) and adhesive material (12), wherein the hollow fiber membranes (4), the hollow aerating shaft (1), the upper end head (5), the lower end head (6) and the adhesive material (12) are fixed together; the aerating head (2), the number of which is at least one, is connected to the hollow aerating shaft (1); the water-producing opening (9) is disposed at the top and/or the bottom of the membrane module; the aerating gas inlet (10) is disposed at one or both ends of the hollow aerating shaft (1); and the protective net (11) covers the periphery of the membrane module. The invention further provides a filter comprising the shaft type submerged hollow fiber membrane module.

### CROSS REFERENCE TO RELATED APPLICATIONS

This application is a continuation of International Patent Application No. PCT/CN2008/070966, filed on May 15, 2008, which claims priority to Chinese Application No. 200720069550.5, filed on May 18, 2007, the entire contents of both of which are incorporated herein by reference.

### TECHNICAL FIELD

The invention relates to a filtering equipment, in particular to a shaft type submerged hollow fiber membrane module. The invention also relates to a filter comprising the shaft type submerged hollow fiber membrane module.

### BACKGROUND ART

Hollow fiber membrane has been widely used in water treatment, biological separation, air filtration and the like. A typical structural arrangement of a hollow fiber membrane module involves a bundle of hollow fiber membranes which are provided in a pressure bearing shell and then fixed at the ends of the bundle. The containment of a bundle of membranes in a shell via such a direct way tends to result in knotting and fouling-up of the fiber membranes, a small throughput of the outcoming water, and a short life of the membrane module.

Thus, the directly fixed membrane module has been modified by various methods, wherein the membrane bundle is covered with a reticular protection layer according to one method, or the membranes are divided into several bundles using partition plates according to another method. Despite some protection they provide for the membranes, these methods still tend to impair the membrane bundle, break the membrane filaments, and suffer from low filtration efficiency, with the problems of water stream distribution and produced-water collection left unsolved. In particular, the problems are more serious when the diameter and the length of the membrane module are relatively large.

With respect to such problems, it is conceived that a water distributing device is provided to the end of the membrane bundle to distribute water decentrally, and the water distributor, the membrane bundle and the shell are adhered and fixed together. However, non-uniform distribution of water still occurs and the unit cost is increased.

So far, a hollow fiber membrane module, the advantages of which include a reasonable structure, reasonable and highly efficient water stream distribution and produced-water collection, enhanced utility efficiency of hollow membrane filaments, high filtering efficiency, high throughput of outcoming water, long life and low unit cost, has not been available in this field.

Therefore, a hollow fiber membrane module, the advantages of which include a reasonable structure, reasonable and highly efficient water stream distribution and produced-water collection, enhanced utility efficiency of hollow membrane filaments, high filtering efficiency, high throughput of outcoming water, long life and low unit cost, is in urgent need in this field.

### SUMMARY OF THE INVENTION

The invention provides a new hollow fiber membrane module, the advantages of which include a reasonable structure, reasonable and highly efficient water stream distribution and produced-water collection, enhanced utility efficiency of hollow membrane filaments, high filtering efficiency, high throughput of outcoming water, long life and low unit cost, so that the existing problems in the field are solved.

In one aspect of the invention, there is provided a shaft type submerged hollow fiber membrane module, comprising a hollow aerating shaft, an aerating head, hollow fiber membranes, an upper end head, a lower end head, an upper end cap, a lower end cap, a water-producing opening, an aerating gas inlet, a protective net and adhesive material, wherein the hollow fiber membranes, the hollow aerating shaft, the upper end head, the lower end head and the adhesive material are fixed together; the aerating head, the number of which is at least one, is connected to the hollow aerating shaft; the water-producing opening is disposed at the top and/or the bottom of the membrane module; the aerating gas inlet is disposed at one or both ends of the hollow aerating shaft; and the protective net covers the periphery of the membrane module.

In a preferred embodiment, the membrane module further comprises a produced-water communicating tube, wherein the produced-water communicating tube, the hollow fiber membranes, the hollow aerating shaft, the upper end head, the lower end head and the adhesive material are fixed together.

In another preferred embodiment, the hollow aerating shaft, opened at one or both ends, is disposed along the central axis of the membrane module.

In another preferred embodiment, when there is only one aerating head, it is disposed around the hollow aerating shaft, facing the exposed part of the hollow membrane filaments near the lower end head; when there are two or more aerating heads, one of them is disposed around the hollow aerating shaft, facing the exposed part of the hollow membrane filaments near the lower end head, and the rest are distributed along the hollow aerating shaft at a constant spacing.

In another preferred embodiment, the aerating head has a shape of central annulus with two or more radial aerating branch tubes disposed thereon; and the peripheral size of the aerating head is equivalent to the outer diameter of the top or lower end head.

In another preferred embodiment, there is one or more produced-water communicating tubes opened at both ends, wherein when there is only one produced-water communicating tube, it is provided directly outside the hollow aerating shaft to be in coaxial; and when there are more produced-water communicating tubes, one of them is provided outside the hollow aerating shaft, and the rest are distributed uniformly around the hollow aerating shaft, or all of them are distributed uniformly around the hollow aerating shaft.

In another preferred embodiment, the two ends of the hollow fiber membrane are fixed on the upper end head and the lower end head, respectively, and the hollow channel of the hollow fiber membrane is open at both ends.

In another preferred embodiment, the protective net covers the periphery of the membrane module and thus separates the hollow fiber membrane from outside; the protective net has a grid of over 50 meshes; and the protective net is made of a material selected from the group consisting of metallic material, inorganic material and organic material.

In another preferred embodiment, the protective net is made of a material selected from the group consisting of stainless steel, nitrilon, nylon and ceramic.

In another aspect of the invention, there is provided a filter comprising the shaft type submerged hollow fiber membrane module.

### BRIEF DESCRIPTION OF THE DRAWINGS

FIG. 1 is a schematic view of a shaft type submerged hollow fiber membrane module having produced-water communicating tubes according to one embodiment of the invention.

FIG. 2 shows the case wherein the produced-water communicating tube according to the embodiment shown in FIG. 1 is arranged eccentrically with respect to the hollow aerating shaft.

FIG. 3 shows the case wherein the produced-water communicating tubes according to the embodiment shown in FIG. 1 are arranged symmetrically with respect to the hollow aerating shaft.

FIG. 4 shows the case wherein the produced-water communicating tube according to the embodiment shown in FIG. 1 is arranged coaxially with respect to the hollow aerating shaft.

FIG. 5 shows the case wherein the produced-water communicating tubes according to the embodiment shown in FIG. 1 are arranged uniformly around the hollow aerating shaft.

### DETAILED DESCRIPTION OF THE INVENTION

After extensive and intensive research, the inventors have found that the use of the particular configuration according to the invention can provide a hollow fiber membrane module, the advantages of which include a reasonable structure, reasonable and highly efficient water stream distribution and produced-water collection, enhanced utility efficiency of hollow membrane filaments, high filtering efficiency, high throughput of outcoming water, long life and low unit cost.

In one aspect of the invention, there is provided a shaft type submerged hollow fiber membrane module, comprising a hollow aerating shaft 1, an aerating head 2, hollow fiber membranes 4, an upper end head 5, a lower end head 6, an upper end cap 7, a lower end cap 8, a water-producing opening 9, an aerating gas inlet 10, a protective net 11 and adhesive material 12, wherein the hollow fiber membranes 4, the hollow aerating shaft 1, the upper end head 5, the lower end head 6 and the adhesive material 12 are fixed together; the aerating head 2, the number of which is at least one, is connected to the hollow aerating shaft 1; the water-producing opening 9 is disposed at the top and/or the bottom of the membrane module; the aerating gas inlet 10 is disposed at one or both ends of the hollow aerating shaft 1; and the protective net 11 covers the periphery of the membrane module.

In a preferred embodiment of the invention, the membrane module may further comprise a produced-water communicating tube 3, wherein the produced-water communicating tube 3, the hollow fiber membranes 4, the hollow aerating shaft 1, the upper end head 5, the lower end head 6 and the adhesive material 12 are fixed together.

In another preferred embodiment of the invention, the hollow aerating shaft 1, opened at one or both ends, may be disposed along the central axis of the membrane module.

In another preferred embodiment of the invention, when there is only one aerating head 2, it may be disposed around the hollow aerating shaft 1, facing the exposed part of the hollow membrane filaments near the lower end head 6; when there are two or more aerating heads 2, one of them may be disposed around the hollow aerating shaft 1, facing the exposed part of the hollow membrane filaments near the lower end head 6, and the rest may be distributed along the hollow aerating shaft 1 at a constant spacing.

In another preferred embodiment of the invention, the aerating head 2 may have a shape of central annulus with two or more radial aerating branch tubes disposed thereon; and the peripheral size of the aerating head 2 is equivalent to the outer diameter of the upper end head 5 or the lower end head 6.

In another preferred embodiment of the invention, there may be one or more produced-water communicating tubes 3 which may be opened at both ends, wherein when there is only one produced-water communicating tube 3, it may be provided directly outside the hollow aerating shaft 1 to be in coaxial; and when there are more produced-water communicating tubes 3, one of them may be provided outside the hollow aerating shaft 1, and the rest may be distributed uniformly around the hollow aerating shaft 1, or all of them may be distributed uniformly around the hollow aerating shaft 1.

In another preferred embodiment of the invention, the two ends of the hollow fiber membrane 4 may be fixed on the upper end head 5 and the lower end head 6, respectively, and the hollow channel of the hollow fiber membrane 4 may be open at both ends.

In another preferred embodiment of the invention, the protective net 11 covers the periphery of the membrane module and thus separates the hollow fiber membrane 4 from outside; the protective net 11 has a grid of over 50 meshes; and the protective net 11 is made of a material selected from the group consisting of metallic material, inorganic material and organic material.

In another preferred embodiment of the invention, the protective net 11 is made of a material selected from the group consisting of stainless steel, nitrilon, nylon and ceramic.

In another aspect of the invention, there is provided a filter comprising the shaft type submerged hollow fiber membrane module.

Further description of the invention will be made with reference to the accompanied drawings. However, it is to be understood that they are only used for the purpose of illustrating the invention without limiting the scope thereof.

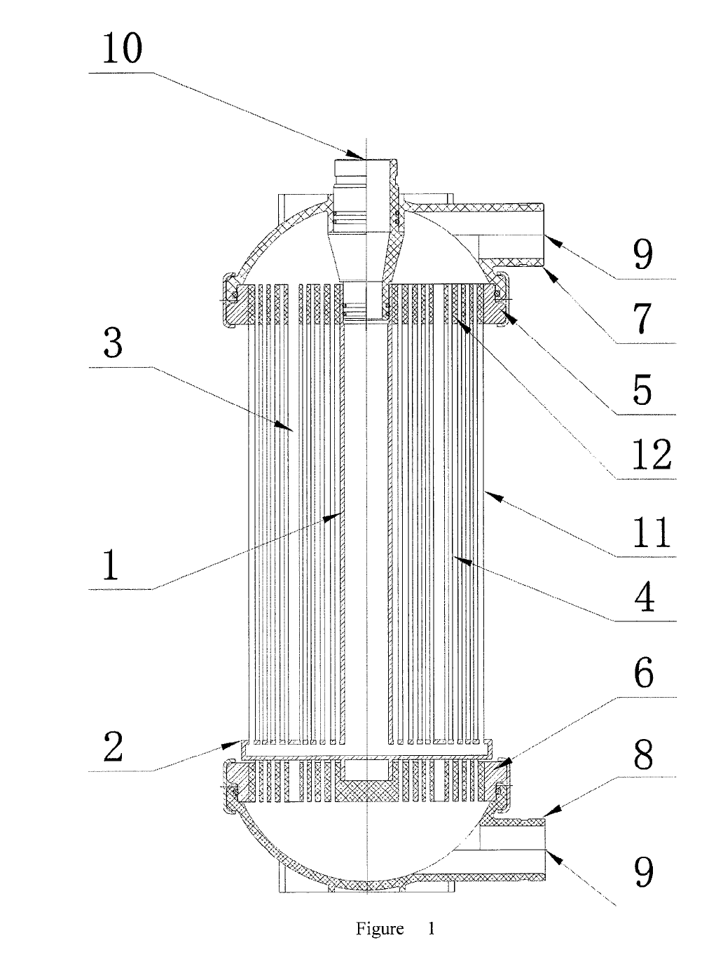

FIG. 1 shows a shaft type submerged hollow fiber membrane module having produced-water communicating tubes 3 according to one embodiment of the invention. As shown in FIG. 1, the hollow fiber membrane module is a substantially cylindrical structure comprising a hollow aerating shaft 1, an aerating head 2 connected to the hollow aerating shaft 1, produced-water communicating tubes 3, hollow fiber membranes 4, an upper end head 5, a lower end head 6, an upper end cap 7, a lower end cap 8, water producing openings 9 disposed at the top and bottom ends of the membrane module, respectively, an aerating gas inlet 10 disposed on the hollow aerating shaft 1, a protective net 11 covering the periphery of the membrane module and adhesive material 12. The produced-water communicating tubes 3, the hollow fiber membranes 4, the hollow aerating shaft 1, the upper end head 5, the lower end head 6, and the adhesive material 12 are fixed together. The hollow aerating shaft 1, opened at one or both ends, is disposed along the central axis of the membrane module. The aerating head 2 is disposed around the hollow aerating shaft 1, facing the exposed part of the hollow membrane filaments near the lower end head 6. The aerating head 2 may have a shape of central annulus with two or more radial aerating branch tubes (not shown) disposed thereon; and the peripheral size of the aerating head 2 is equivalent to the outer diameter of the upper end head 5 or the lower end head 6. There may be one or more produced-water communicating tubes 3 which may be opened at both ends. The two ends of the hollow fiber membrane 4 may be fixed on the upper end head 5 and the lower end head 6, respectively, and the hollow channel of the hollow fiber membrane 4 is open at both ends. The protective net 11 covers the periphery of the membrane module and thus separates the hollow fiber membrane 4 from outside; the protective net 11 has a grid of over 50 meshes; and the protective net 11 is made of a material selected from the group consisting of metallic material, inorganic material, organic material and the like, preferably from the group consisting of stainless steel, nitrilon, nylon, ceramic and the like.

FIG. 2 shows the case wherein the produced-water communicating tube 3 according to the embodiment shown in FIG. 1 is arranged eccentrically with respect to the hollow aerating shaft 1. As shown in FIG. 2, the produced-water communicating tube 3 is arranged eccentrically at one side of the hollow aerating shaft 1.

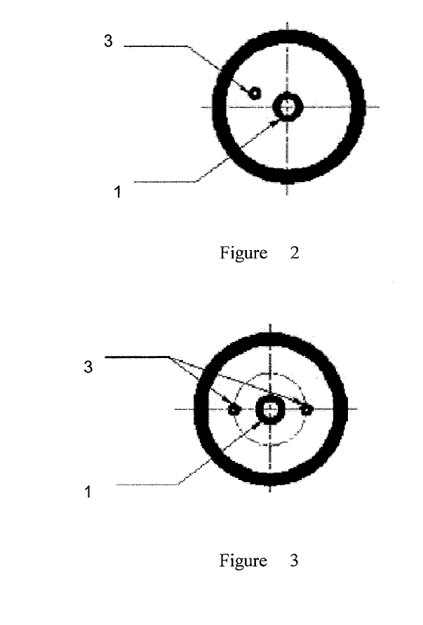

FIG. 3 shows the case wherein the produced-water communicating tubes 3 according to the embodiment shown in FIG. 1 are arranged symmetrically with respect to the hollow aerating shaft 1. As shown in FIG. 3, the produced-water communicating tubes 3 are arranged symmetrically at two sides of the hollow aerating shaft 1.

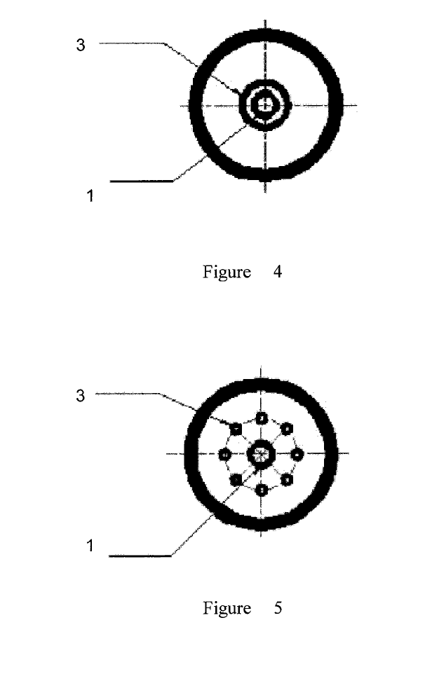

FIG. 4 shows the case wherein the produced-water communicating tube 3 according to the embodiment shown in FIG. 1 is arranged coaxially with respect to the hollow aerating shaft 1. As shown in FIG. 4, the produced-water communicating tube 3 is arranged coaxially with respect to the hollow aerating shaft 1.

FIG. 5 shows the case wherein the produced-water communicating tubes 3 according to the embodiment shown in FIG. 1 are arranged uniformly around the hollow aerating shaft 1. As shown in FIG. 5, the produced-water communicating tubes 3 are arranged uniformly around the hollow aerating shaft 1.

The main advantages of the invention include:

The shaft type submerged hollow fiber membrane module has a reasonable structure, reasonable and highly efficient water stream distribution and produced-water collection, enhanced utility efficiency of hollow membrane filaments, high filtering efficiency, high throughput of outcoming water, long life and low unit cost, and it is thus quite suited to be used directly in turbid water source.

Although the invention has been described in detail for the purpose of clarity and understanding, it will be apparent to those skilled in the art, after reading the specification of this application, that various modifications and changes may be made to the invention without departing from the spirit and nature of the invention. Such modifications and changes are intended to be included in the scope defined by the appended claims and equivalents thereof.

What is claimed is:

1. A shaft type submerged hollow fiber membrane module, comprising a hollow aerating shaft (1), an aerating head (2), hollow fiber membranes (4), an upper end head (5), a lower end head (6), an upper end cap (7), a lower end cap (8), a water-producing opening (9), an aerating gas inlet (10), a protective net (11) and adhesive material (12), wherein the hollow fiber membranes (4), the hollow aerating shaft (1), the upper end head (5), the lower end head (6) and the adhesive material (12) are fixed together; the aerating head (2), the number of which is at least one, is connected to the hollow aerating shaft (1); the water-producing opening (9) is disposed at the top and/or the bottom of the membrane module; the aerating gas inlet (10) is disposed at one or both ends of the hollow aerating shaft (1); and the protective net (11) covers the periphery of the membrane module.

2. The shaft type submerged hollow fiber membrane module of claim 1, further comprising a produced-water communicating tube (3), wherein the produced-water communicating tube (3), the hollow fiber membranes (4), the hollow aerating shaft (1), the upper end head (5), the lower end head (6) and the adhesive material (12) are fixed together.

3. The shaft type submerged hollow fiber membrane module of claim 1 or 2, wherein the hollow aerating shaft (1), opened at one or both ends, is disposed along the central axis of the membrane module.

4. The shaft type submerged hollow fiber membrane module of claim 1 or 2, wherein when there is only one aerating head (2), it is disposed around the hollow aerating shaft (1), facing the exposed part of the hollow membrane filaments near the lower end head (6); when there are two or more aerating heads (2), one of them is disposed around the hollow aerating shaft (1), facing the exposed part of the hollow membrane filaments near the lower end head (6), and the rest are distributed along the hollow aerating shaft (1) at a constant spacing.

5. The shaft type submerged hollow fiber membrane module of claim 1 or 2, wherein the aerating head (2) has a shape of central annulus with two or more radial aerating branch tubes disposed thereon; and the peripheral size of the aerating head (2) is equivalent to the outer diameter of the upper end head (5) or the lower end head (6).

6. The shaft type submerged hollow fiber membrane module of claim 2, wherein there is one or more produced-water communicating tubes (3) which are opened at both ends, and wherein when there is only one produced-water communicating tube (3), it is provided directly outside the hollow aerating shaft (1) to be in coaxial; and when there are more produced-water communicating tubes (3), one of them is provided outside the hollow aerating shaft (1), and the rest are distributed uniformly around the hollow aerating shaft (1), or all of them are distributed uniformly around the hollow aerating shaft (1).

7. The shaft type submerged hollow fiber membrane module of claim 1 or 2, wherein the two ends of the hollow fiber membrane (4) are fixed on the upper end head 5 and the lower end head 6, respectively, and the hollow channel of the hollow fiber membrane (4) is open at both ends.

8. The shaft type submerged hollow fiber membrane module of claim 1 or 2, wherein the protective net (11) covers the periphery of the membrane module and thus separates the hollow fiber membrane (4) from outside; the protective net (11) has a grid of over 50 meshes; and the protective net (11) is made of a material selected from the group consisting of metallic material, inorganic material and organic material.

9. The shaft type submerged hollow fiber membrane module of claim 8, wherein the protective net (11) is made of a material selected from the group consisting of stainless steel, nitrilon, nylon and ceramic.

10. A filter comprising a shaft type submerged hollow fiber membrane module according to any one of claims 1-9.
